(19) United States
(12) Patent Application Publication
(10) Pub. No.: US 2024/0349127 A1
(43) Pub. Date: Oct. 17, 2024

(54) METHODS, APPARATUSES, AND COMPUTER READABLE MEDIA FOR TERAHERTZ CHANNEL COMMUNICATION

(71) Applicant: NOKIA SOLUTIONS AND NETWORKS OY, Espoo (FI)

(72) Inventors: Wenjian WANG, Shanghai (CN); Nuan SONG, Shanghai (CN); Tao YANG, Shanghai (CN)

(21) Appl. No.: 18/682,659

(22) PCT Filed: Sep. 16, 2021
(86) PCT No.: PCT/CN2021/118706

§ 371 Date: Feb. 9, 2024

(51) Int. Cl. H04W 28/20; H04W 28/02; H04W 64/00

(52) U.S. Cl. CPC H04W 28/20; H04W 28/0226; H04W 64/00

(57) ABSTRACT

Disclosed are communication methods for terahertz channel communication. An example communication method performed by a user equipment device may include receiving, from a network apparatus, mapping information on property of distance and bandwidth, determining Receiving mapping information a bandwidth of a transmission window based on the mapping information and a distance between the user equipment device and the network apparatus, identifying whether at the bandwidth a subcarrier is an available subcarrier or a virtual subcarrier which fails to support reliable symbol transmission, estimating channel information at the bandwidth in one or more window available subcarriers, and transmitting, to the network apparatus, aware information of the user equipment device, the aware information comprising the channel information, positioning and ephemeris information, and subarray index of the user equipment device. Related communication apparatuses and computer readable media are also disclosed.

### TECHNICAL FIELD

Various embodiments relate to methods, apparatuses, and computer readable media for terahertz channel communication.

### BACKGROUND

Terahertz (THz) channel provides wireless communication devices with a bandwidth ranging from several tens of GHz up to a few THz. Some phenomenon may cause path loss of THz channel. For example, the absorption by water vapor molecules may affect the propagation of THz-band signals. The path loss may be different for different transmission distances. For communication distances below one meter, the THz band behaves as a single transmission window of several THz wide. As the transmission distance increases, the molecular absorption may cause multiple transmission windows separated by absorption lines. Moreover, the absorption line peaks become both stronger and wider and the bandwidth of each individual transmission window shrinks with the increasing of transmission distance.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a communication method performed by a user equipment device. The communication method may include receiving, from a network apparatus, mapping information on property of distance and bandwidth, determining a bandwidth of a transmission window based on the mapping information and a distance between the user equipment device and the network apparatus, identifying whether at the bandwidth a subcarrier is an available subcarrier or a virtual subcarrier which fails to support reliable symbol transmission, estimating channel information at the bandwidth in one or more available subcarriers, and transmitting, to the network apparatus, aware information of the user equipment device, the aware information comprising the channel information, positioning and ephemeris information, and subarray index of the user equipment device.

In some embodiments, the mapping information may be in a distance-bandwidth mapping table.

In some embodiments, the mapping information may include positioning information and/or ephemeris information of the network apparatus.

In some embodiments, the mapping information may include a lower absorption line center frequency and a higher absorption line center frequency in the transmission window, and a differential frequency between the lower absorption line center frequency and a falling edge frequency at a lower absorption line and a differential frequency between the higher absorption line center frequency and a falling edge frequency at a higher absorption line of the transmission window.

In some embodiments, the mapping information may include parameters of lower and higher frequency decline lines of the transmission window.

In some embodiments, the mapping information may include a distance range and/or a granularity of the distance range.

In some embodiments, the mapping information may be transmitted in a synchronization signal block.

In a second aspect, disclosed is a communication method performed by a network apparatus. The communication method may include transmitting, to a user equipment device, mapping information on property of distance and bandwidth, and receiving, from the user equipment device, aware information of the user equipment device, the aware information comprising channel information, positioning and ephemeris information, and subarray index of the user equipment device, wherein the channel information may be estimated at a bandwidth of a transmission window in one or more available subcarriers, and the bandwidth may be determined based on the mapping information and a distance between the user equipment device and the network apparatus.

In some embodiments, the communication method may further include calculating a precoder and a norma vector according to the channel information, and calculating a signal-to-noise ratio at an available subcarrier based on the norma vector and a noise at the available subcarrier at the user equipment device to determine a bandwidth adaptive modulation and coding scheme index level per stream.

In some embodiments, the communication method may further include calculating a distance between a center of transmitting antenna array and a center of receiving antenna array based on the positioning and ephemeris information, and the subarray index of the user equipment device, to determine an optimal subarray spacing.

In some embodiments, the communication method may further include selecting a modulation order based on the signal-to-noise ratio at the available subcarrier and a bit error rate requirement, extending modulated data to an antenna location at a level of subarray or antenna element according to the modulation order, and calculating a total number of binary bits which are transmitted in downlink over one symbol duration based on the modulation order.

In some embodiments, the mapping information may be transmitted in a synchronization signal block.

In a third aspect, disclosed is a communication apparatus. The communication apparatus may include at least one processor and at least one memory. The at least one memory may include computer program code, and the at least one memory and the computer program code may be configured to, with the at least one processor, cause the communication apparatus as a user equipment device to perform receiving, from a network apparatus, mapping information on property of distance and bandwidth, determining a bandwidth of a transmission window based on the mapping information and a distance between the user equipment device and the network apparatus, identifying whether at the bandwidth a subcarrier is an available subcarrier or a virtual subcarrier which fails to support reliable symbol transmission, estimating channel information at the bandwidth in one or more available subcarriers, and transmitting, to the network apparatus, aware information of the user equipment device, the aware information comprising the channel information, positioning and ephemeris information, and subarray index of the user equipment device.

In some embodiments, the mapping information may be in a distance-bandwidth mapping table.

In some embodiments, the mapping information may include positioning information and/or ephemeris information of the network apparatus.

In some embodiments, the mapping information may include a lower absorption line center frequency and a higher absorption line center frequency in the transmission window, and a differential frequency between the lower absorption line center frequency and a falling edge frequency at a lower absorption line and a differential frequency between the higher absorption line center frequency and a falling edge frequency at a higher absorption line of the transmission window.

In some embodiments, the mapping information may include parameters of lower and higher frequency decline lines of the transmission window.

In some embodiments, the mapping information may include a distance range and/or a granularity of the distance range.

In some embodiments, the mapping information may be transmitted in a synchronization signal block.

In a fourth aspect, disclosed is a communication apparatus. The communication apparatus may include at least one processor and at least one memory. The at least one memory may include computer program code, and the at least one memory and the computer program code may be configured to, with the at least one processor, cause the communication apparatus as a network apparatus to perform transmitting, to a user equipment device, mapping information on property of distance and bandwidth, and receiving, from the user equipment device, aware information of the user equipment device, the aware information comprising channel information, positioning and ephemeris information, and subarray index of the user equipment device, wherein the channel information may be estimated at a bandwidth of a transmission window in one or more available subcarriers, and the bandwidth may be determined based on the mapping information and a distance between the user equipment device and the network apparatus.

In some embodiments, the at least one memory and the computer program code may be further configured to, with the at least one processor, cause the communication apparatus to further perform calculating a precoder and a norma vector according to the channel information, and calculating a signal-to-noise ratio at an available subcarrier based on the norma vector and a noise at the available subcarrier at the user equipment device to determine a bandwidth adaptive modulation and coding scheme index level per stream.

In some embodiments, the at least one memory and the computer program code may be further configured to, with the at least one processor, cause the communication apparatus to further perform calculating a distance between a center of transmitting antenna array and a center of receiving antenna array based on the positioning and ephemeris information, and the subarray index of the user equipment device, to determine an optimal subarray spacing.

In some embodiments, the at least one memory and the computer program code may be further configured to, with the at least one processor, cause the communication apparatus to further perform selecting a modulation order based on the signal-to-noise ratio at the available subcarrier and a bit error rate requirement, extending modulated data to an antenna location at a level of subarray or antenna element according to the modulation order, and calculating a total number of binary bits which are transmitted in downlink over one symbol duration based on the modulation order.

In some embodiments, the mapping information may be transmitted in a synchronization signal block.

In a fifth aspect, disclosed is a communication apparatus. The communication apparatus as a user equipment device may include means for receiving, from a network apparatus, mapping information on property of distance and bandwidth, means for determining a bandwidth of a transmission window based on the mapping information and a distance between the user equipment device and the network apparatus, means for identifying whether at the bandwidth a subcarrier is an available subcarrier or a virtual subcarrier which fails to support reliable symbol transmission, means for estimating channel information at the bandwidth in one or more available subcarriers, and means for transmitting, to the network apparatus, aware information of the user equipment device, the aware information comprising the channel information, positioning and ephemeris information, and subarray index of the user equipment device.

In some embodiments, the mapping information may be in a distance-bandwidth mapping table.

In some embodiments, the mapping information may include positioning information and/or ephemeris information of the network apparatus.

In some embodiments, the mapping information may include a lower absorption line center frequency and a higher absorption line center frequency in the transmission window, and a differential frequency between the lower absorption line center frequency and a falling edge frequency at a lower absorption line and a differential frequency between the higher absorption line center frequency and a falling edge frequency at a higher absorption line of the transmission window.

In some embodiments, the mapping information may include parameters of lower and higher frequency decline lines of the transmission window.

In some embodiments, the mapping information may include a distance range and/or a granularity of the distance range.

In some embodiments, the mapping information may be transmitted in a synchronization signal block.

In a sixth aspect, disclosed is a communication apparatus. The communication apparatus as a network apparatus may include means for transmitting, to a user equipment device, mapping information on property of distance and bandwidth, and means for receiving, from the user equipment device, aware information of the user equipment device, the aware information comprising channel information, positioning and ephemeris information, and subarray index of the user equipment device, wherein the channel information may be estimated at a bandwidth of a transmission window in one or more available subcarriers, and the bandwidth may be determined based on the mapping information and a distance between the user equipment device and the network apparatus.

In some embodiments, the communication apparatus may further include means for calculating a precoder and a norma vector according to the channel information and means for calculating a signal-to-noise ratio at an available subcarrier based on the norma vector and a noise at the available subcarrier at the user equipment device to determine a bandwidth adaptive modulation and coding scheme index level per stream.

In some embodiments, the communication apparatus may further include means for calculating a distance between a center of transmitting antenna array and a center of receiving antenna array based on the positioning and ephemeris information, and the subarray index of the user equipment device, to determine an optimal subarray spacing.

In some embodiments, the communication apparatus may further include means for selecting a modulation order based on the signal-to-noise ratio at the available subcarrier and a bit error rate requirement, means for extending modulated data to an antenna location at a level of subarray or antenna element according to the modulation order, and means for calculating a total number of binary bits which are transmitted in downlink over one symbol duration based on the modulation order.

In some embodiments, the mapping information may be transmitted in a synchronization signal block.

In a seventh aspect, a computer readable medium is disclosed. The computer readable medium may include instructions stored thereon for causing a communication apparatus as a user equipment device to perform receiving, from a network apparatus, mapping information on property of distance and bandwidth, determining a bandwidth of a transmission window based on the mapping information and a distance between the user equipment device and the network apparatus, identifying whether at the bandwidth a subcarrier is an available subcarrier or a virtual subcarrier which fails to support reliable symbol transmission, estimating channel information at the bandwidth in one or more available subcarriers, and transmitting, to the network apparatus, aware information of the user equipment device, the aware information comprising the channel information, positioning and ephemeris information, and subarray index of the user equipment device.

In some embodiments, the mapping information may be in a distance-bandwidth mapping table.

In some embodiments, the mapping information may include positioning information and/or ephemeris information of the network apparatus.

In some embodiments, the mapping information may include a lower absorption line center frequency and a higher absorption line center frequency in the transmission window, and a differential frequency between the lower absorption line center frequency and a falling edge frequency at a lower absorption line and a differential frequency between the higher absorption line center frequency and a falling edge frequency at a higher absorption line of the transmission window.

In some embodiments, the mapping information may include parameters of lower and higher frequency decline lines of the transmission window.

In some embodiments, the mapping information may include a distance range and/or a granularity of the distance range.

In some embodiments, the mapping information may be transmitted in a synchronization signal block.

In an eighth aspect, a computer readable medium is disclosed. The computer readable medium may include instructions stored thereon for causing a communication apparatus as a network apparatus to perform transmitting, to a user equipment device, mapping information on property of distance and bandwidth, and receiving, from the user equipment device, aware information of the user equipment device, the aware information comprising channel information, positioning and ephemeris information, and subarray index of the user equipment device, wherein the channel information may be estimated at a bandwidth of a transmission window in one or more available subcarriers, and the bandwidth may be determined based on the mapping information and a distance between the user equipment device and the network apparatus.

In some embodiments, the computer readable medium may further include instructions stored thereon for causing the communication apparatus to further perform calculating a precoder and a norma vector according to the channel information, and calculating a signal-to-noise ratio at an available subcarrier based on the norma vector and a noise at the available subcarrier at the user equipment device to determine a bandwidth adaptive modulation and coding scheme index level per stream.

In some embodiments, the computer readable medium may further include instructions stored thereon for causing the communication apparatus to further perform calculating a distance between a center of transmitting antenna array and a center of receiving antenna array based on the positioning and ephemeris information, and the subarray index of the user equipment device, to determine an optimal subarray spacing.

In some embodiments, the computer readable medium may further include instructions stored thereon for causing the communication apparatus to further perform selecting a modulation order based on the signal-to-noise ratio at the available subcarrier and a bit error rate requirement, extending modulated data to an antenna location at a level of subarray or antenna element according to the modulation order, and calculating a total number of binary bits which are transmitted in downlink over one symbol duration based on the modulation order.

In some embodiments, the mapping information may be transmitted in a synchronization signal block.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for providing a hierarchical modulation mechanism for THz channel communication according to embodiments of the present disclosure.

FIG. 2 shows an example bandwidth determination scheme in THz band according to an embodiment of the present disclosure.

FIG. 3 shows an example bandwidth determination scheme in THz band according to an embodiment of the present disclosure.

FIG. 4 shows an example pattern of THz modulation at an array-of-subarrays at antenna level according to an embodiment of the present disclosure.

FIG. 5 shows an example THz hierarchically special mapping illustration at subarray and antenna element level according to an embodiment of the present disclosure.

FIG. 6 shows a flow chart illustrating an example method for THz channel communication according to an embodiment of the present disclosure.

FIG. 7 shows a flow chart illustrating an example method for THz channel communication according to an embodiment of the present disclosure.

FIG. 8 shows a block diagram illustrating an example apparatus for THz channel communication according to an embodiment of the present disclosure.

FIG. 9 shows a block diagram illustrating an example apparatus for THz channel communication according to an embodiment of the present disclosure.

FIG. 10 shows a block diagram illustrating an example apparatus for THz channel communication according to an embodiment of the present disclosure.

FIG. 11 shows a block diagram illustrating an example apparatus for THz channel communication according to an embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Embodiments of the present disclosure provide a mechanism for THz channel communication. THz channel characteristics are utilized to avoid impact on link adaption and thus avoid influence on system throughput according to the embodiments of the present disclosure. Due to the THz channel feature, the available bandwidth may be determined by the communication distance instead of being directly configured to the UE devices.

Signal propagation at THz frequencies is quasi-optical. Due to large reflection losses, the THz channel may be dominated by a line of sight (LoS) path and may be with possibly very few, if any, non-LoS (NLoS) reflected rays. Scattered and refracted rays can be neglected. The frequency-dependent LoS path gain may be calculated by the formula (1) below.

$${PG}_{{m}_{r} {n}_{r} , {m}_{t} {n}_{t}}^{LoS} = \frac{c}{4 π {f}_{c} {d}_{{m}_{r} {n}_{r} , {m}_{t} {n}_{t}}} \times {e}^{- \frac{1}{2} {k}_{abs} ( {f}_{c} ) {d}_{{m}_{r} {n}_{r} , {m}_{t} {n}_{t}}} {e}^{- j \frac{2 π {f}_{c}}{c} {d}_{{m}_{r} {n}_{r} , {m}_{t} {n}_{t}}} \qquad ( 1 )$$

where f_{c} is the central frequency of the THz channel, C is the light speed, dₘ_{ᵣ}ₙ_{ᵣ}_{,m}_{ₜ}ₙ_{ₜ} is the effective distance between the transmitting and receiving antenna subarrays (SAs), and k_{abs}(fₑ) is the frequency-dependent absorption coefficient of the medium. mᵣ,nᵣmₜ, nₜ=1⋅ ⋅ ⋅ P, and P is the number of SAs in a row or a column of the antenna array. Due to a beamforming gain, a single dominant ray exists between the transmitting and receiving SAs. So the 1 Hz channel may be assumed to be the LoS path, which may support simultaneous transmission of multiple data streams at several GHz.

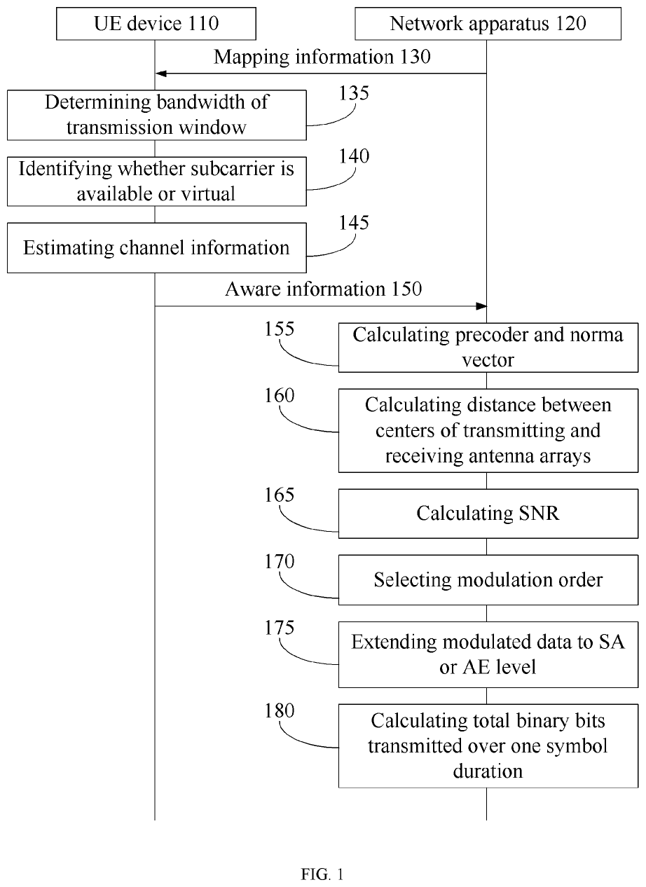

FIG. 1 shows an exemplary sequence diagram for providing a hierarchical modulation mechanism for 1 Hz channel communication according to embodiments of the present disclosure. Referring to the FIG. 1, a user equipment (UE) device 110 may be an example UE device, and a network apparatus 120 may be an example apparatus of network side, e.g., in a base station (BS) or may function as the BS. The UE device 110 is associated with a cell the BS covers.

The network apparatus 120 may transmit mapping information 130 on property of distance and bandwidth to the UE device 110. The mapping information 130 may assist the hierarchical modulation mechanism to effectively maximize the THz channel utilization. In an embodiment, the mapping information may be listed in a distance-bandwidth mapping table (MT). The following Table 1 is shown as an example of MT.

| Item | | |
|---|---|---|
| No. | MT contents | Explanation |
| 1 | Total Frequency bandwidth and | For the specific single transmission window, |
| | multiple transmission window | e.g., window above 1 THz. The available |
| | | bandwidth can go from 91.55 GHz down to |
| | | 57.98 GHz when the communication distance |
| | | increases from 1 m to 10 m. |
| 2 | The lower and higher absorption | f_{c}^{up}, f_{c}^{down}. |
| | line center frequencies in the | |
| | single transmission window | |
| 3 | The differential frequencies | Δf^{up}, Δf^{down}. |
| | between the higher and lower | |
| | absorption line center frequencies | |
| | (the peak of the parabola) and the | |
| | falling edge of the parabola at the | |
| | higher and lower absorption line | |
| 4 | BS positioning information and | If the BS is moving, e.g., an air-borne BS like |
| | ephemeris | an unmanned aerial vehicle (UAV) station, etc. |
| | | The BS ephemeris may comprise a moving |
| | | direction, a moving velocity, and a planned |
| | | route of movement of the BS. |
| 5 | distance range and granularity of | Distance range is from 1 m~100 m with |
| | distance range | granularity of 1 m. |
| | | Or defining a Cascading level (hierarchical |
| | | level) Mₕ if the available bandwidth of a |
| | | closer UE device is integral multiple of a farther |
| | | UE device. The demodulator at UE device is |
| | | first to estimate the bandwidth l/Tₛ′ and based |
| | | $on the estimated factor m = \frac{{{T}_{s}}^{′}}{{T}_{s}} , and then$ |
| | | the received signal is demodulated as a |
| | | ${4}^{{M}_{h} - m + 1} QAM at a \frac{1}{m {T}_{s}} rate , where {M}_{h}$ |
| | | is the hierarchical level, m is an integer and Tₛ |
| | | is the inverse of the bandwidth available at the |
| | | closest UE device. |
| 6 | Humidity | Standard atmosphere with 40% |
| 7 | Pressure | 1 atm |
| 8 | Relevant parameters at a single | kᵢ^{up}, bᵢ^{up}, kᵢ^{down}, bᵢ^{down} |
| | window i | |

The contents of the MT will be described in detail later. It may be appreciated that the Table 1 above is an example of the MT. The MT may include other contents not shown in the Table 1, and some contents shown in the Table 1 may be omitted in the MT. In addition, not all contents in the MT need to be transmitted from the network apparatus 120 to the LUE device 110. The mapping information 130 may be determined by the network apparatus 120, and additionally or alternatively, the network apparatus 120 may receive the mapping information 130 from other apparatus, e.g. an apparatus in core network (CN).

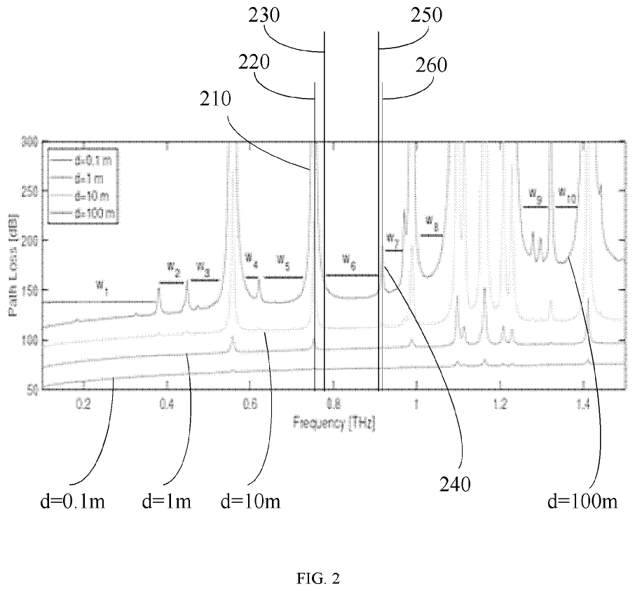

FIG. 2 shows an example bandwidth determination scheme in THz band according to an embodiment of the present disclosure. In the FIG. 2, the path loss in dB is shown for different transmission distances, for a standard atmosphere with 400o humidity. For transmission distances below one meter, where the number of water vapor molecules found along the path is small, the THz band behaves as a single transmission window several THz wide. As the transmission distance increases, for example, for the distance of 100 meters, molecular absorption lines define multiple transmission windows, such as w₁, w₂, . . . w₁₀. As is shown in the FIG. 2, an absorption line may form a parabola with one peak and two falling edges. For example, the single transmission window w₆ is between an absorption line 210 and an absorption line 240. The absorption line 210 has an absorption line center 220, with is at the peak of the absorption line 210. The absorption line 240 has an absorption line center 260, with is at the peak of the absorption line 240. For the single transmission window w₆, the absorption line 210 has a falling edge 230 and the absorption line 240 has a falling edge 250.

In an embodiment, the mapping information 130 may comprise a lower absorption line center frequency and a higher absorption line center frequency in the transmission window, and a differential frequency between the lower absorption line center frequency and a falling edge frequency at a lower absorption line and a differential frequency between the higher absorption line center frequency and a falling edge frequency at a higher absorption line of the transmission window. The lower absorption line center frequency and the higher absorption line center frequency in the transmission window may be, for example, the item 2 in the Table 1, and the differential frequency between the lower absorption line center frequency and the falling edge frequency at the lower absorption line and the differential frequency between the higher absorption line center frequency and the falling edge frequency at the higher absorption line of the transmission window may be, for example, the item 3 in the Table 1.

For a single transmission window i, e.g. the w₆, the center transmission frequency in the single transmission window i may be defined as f_{c}. The lower absorption line center frequency in the transmission window i may be defined as f_{c}^{down}, for w₆, e.g., the frequency at the absorption line center 220. The higher absorption line center frequency in the transmission window i may be defined as f_{c}^{up}, for w₆, e.g., the frequency at the absorption line center 260. The differential frequency between the higher absorption line center frequency (the peak of the parabola) and the falling edge of the parabola at the higher absorption line may be defined as Δf^{up}, for w₆, e.g., the Δf^{up} may be the frequency at the absorption line center 260 minus the frequency at the falling edge 250. The differential frequency between the lower absorption line center frequency (the peak of the parabola) and the falling edge of the parabola at the lower absorption line may be defined as Δ_{c}^{up}, for w₆, e.g., the AJ-down may be the frequency at the falling edge 230 minus the frequency at the absorption line center 220.

The Δf^{up} and the Δf^{down} may be calculated by the following formula (2).

$$\{ \begin{matrix}Δ {f}^{down} = 100 c \sqrt{\frac{1}{\frac{1}{{( {f}_{c} / 100 c - {b}_{1} )}^{2} + {b}_{2}} + {b}_{3} \frac{ln ( γ )}{d μ}} - {b}_{2}} \\ Δ {f}^{up} = 100 c \sqrt{\frac{1}{\frac{1}{{( {f}_{c} / 100 c - {g}_{1} )}^{2} + {b}_{2}} + {g}_{3} \frac{ln ( γ )}{d μ}} - {g}_{2}} \\ {b}_{1} = 10.8 \; 42 {cm}^{- 1} , {b}_{2} = 0.0 \; 098 {cm}^{- 2} , {b}_{3} = 4.49 \times {10}^{3} π \\ {g}_{1} = 12.6 \; 79 {cm}^{- 1} , {g}_{2} = 12.6 \; 79 {cm}^{- 1} , {g}_{3} = 4.7 \times 1 {0}^{2} π\end{matrix} \qquad ( 2 )$$

where μ denotes the volume of the mixing ratio of water vapor and y denotes the tolerance of the absorption loss deviation, cm is centimeter, d is the distance between the UE device 110 and the network apparatus 120, and b₁, b₂, b₃ and g₁, g₂, 9₃ are parameters.

The f_{c}^{up}, f_{c}^{down}, Δf^{up}, Δf^{down} at every granularity of the transmission distance on the single transmission window i may be included in the mapping information 130 and transmitted to the UE device 110.

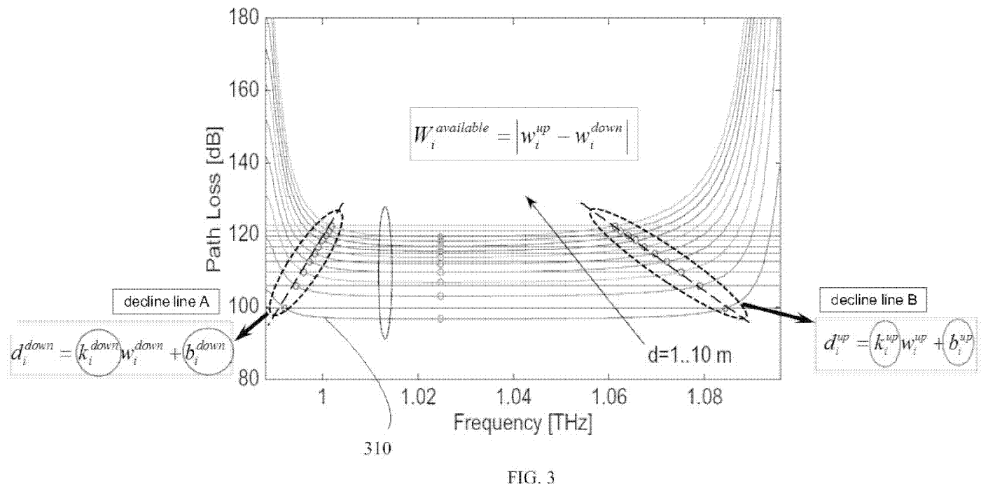

FIG. 3 shows an example bandwidth determination scheme in THz band according to an embodiment of the present disclosure. In the FIG. 3, one single transmission window i between two absorption lines is shown as an example. Curves such as a curve 310 are shown as path losses with respect to the frequency at different transmission distances.

The FIG. 3 and the following formula (3) depict lower and higher frequency decline lines A and B.

$$\{ \begin{matrix}{d}_{i}^{up} = {k}_{i}^{up} {w}_{i}^{up} + {b}_{i}^{up} \\ {d}_{i}^{down} = {k}_{i}^{down} {w}_{i}^{down} + {b}_{i}^{down} \\ {d}_{i}^{up} = {d}_{i}^{down}\end{matrix} \qquad ( 3 )$$

where the kᵢ^{up}, bᵢ^{up}, kᵢ^{down}, bᵢ^{down} are relevant parameters of the lower and higher frequency decline lines A and B, in which the kᵢ^{up} and bᵢ^{up} are parameters of the higher frequency decline line B and the kᵢ^{down} and bᵢ^{down} are parameters of the lower frequency decline line A, and the dᵢ^{up} and dᵢ^{down} are the transmission distance. The kᵢ^{down} may be the gradient of the decline line A, and the bᵢ^{down} may be the intercept of the lower frequency decline line A. The kᵢ^{up} may be the gradient of the decline line B, and the bᵢ^{up} may be the intercept of the higher frequency decline line B.

In an embodiment, the mapping information 130 may comprise the parameters of the lower and higher frequency decline lines of the transmission window. The parameters may be, for example, the kᵢ^{up}, bᵢ^{up}, kᵢ^{down}, bᵢ^{down}, which may be, e.g. the item 8 in the Table 1. As is mentioned above, the kᵢ^{up} and bᵢ^{up} are parameters of the higher frequency decline line B and the kᵢ^{down} and bᵢ^{down} are parameters of the lower frequency decline line A. In a case where the mapping information 130 includes the relevant parameters of lower and higher frequency decline lines A and B instead of, e.g. the f_{c}^{up}, f_{c}^{down}, Δf^{up}, Δf^{down}, the overhead of the communication system may be reduced.

In an embodiment, the mapping information 130 may comprise positioning information and/or ephemeris information of the network apparatus 120. The positioning information and/or the ephemeris information may be, e.g., the item 4 in the Table 1. The positioning information of the network apparatus 120 may be used by the UE device 110 to calculate the distance between the UE device 110 and the network apparatus 120, if the network apparatus 120 is stationary. In a case where the network apparatus 120 is moving, for example, in an air-borne BS such as an UAV station, etc., the mapping information 130 may further comprise the ephemeris information of the network apparatus 120 such that the UE device 110 may calculate the distance between the UE device 110 and the network apparatus 120 based on the mapping information 130. The ephemeris information of the network apparatus 120 is also the ephemeris information of the BS and may comprise a moving direction, a moving velocity, and a planned route of movement of the BS.

In an embodiment, the mapping information 130 may optionally comprise a distance range and/or a granularity of the distance range. The distance range and the granularity may be, for example, the item 5 in the Table 1. Alternatively or additionally, the mapping information 130 may optionally comprise a total Frequency bandwidth and multiple transmission window, e.g. the item 1 in the Table 1, humidity, e.g., the item 6 in the Table 1, and/or pressure, e.g., the item 7 in the Table 1.

In an embodiment, the mapping information 130 may be transmitted in a synchronization signal block (SSB). In an embodiment, the SSB may be a synchronization signal and physical broadcast channel (PBCH) block.

Referring back to the FIG. 1, in an operation 135, the UE device 110 may determine a bandwidth of a transmission window based on the mapping information 130 and a distance between the user equipment device 110 and the network apparatus 120. The UE device 110 may have global navigation satellite system (GNSS) positioning ability. As is described above, the UE device 110 may calculate the distance between the user equipment device 110 and the network apparatus 120 based on the positioning information and/or ephemeris information of the network apparatus 120. Because of the ambiguity at the higher and lower absorption line center frequencies on THz, the UE device 110 identifies UE-specific bandwidth and subcarriers.

The bandwidth of the transmission window may be denoted as W(d), representing the bandwidth W is at the transmission distance d, which may be the distance between the user equipment device 110 and the network apparatus 120. There are two solutions, one option (opt. 1) may be based on the formulas (2) and (4) for high accuracy, another option (opt.2) may be based on the formulas (3) and (4) for low complexity.

$$\{ \begin{matrix}W ( d ) = {f}_{c}^{up} ( d ) - Δ {f}^{up} ( d ) - & opt . 1 ( high accuracy ) \\ ( {f}_{c}^{down} ( d ) + Δ {f}^{down} ( d ) ) & \\ W ( d ) = {W}_{i}^{available} = \vert {w}_{i}^{up} - {w}_{i}^{down} \vert & opt . 2 ( low complexity ) \\ s . t . {\vert h ( f + Δ f ) - h ( f ) \vert}^{2} \leq ε & \end{matrix} \qquad ( 4 )$$

$$N = ⌊ \frac{W ( d )}{Δ f} ⌋ \qquad ( 5 )$$

For the opt.1, the f_{c}^{up}, f_{c}^{down}, Δf_{c}^{up}, Δf_{c}^{up} down up Adown may be at the transmission distance d and denoted as f_{c}^{up}(d), f_{c}^{down}(d), Δf^{up}(d), and Δf^{down}(d), respectively.

For the opt.2, because the UE device 110 may have calculated the dᵢ^{up} and dᵢ^{down} according to the formula (3), the UE device 110 may calculate the wᵢ^{up} and wᵢ^{down}, where the wᵢ^{up} and wᵢ^{down} may be briefly utilized to be the higher limit and the lower limit of the available bandwidth of the transmission window i. The UE device 110 may thus calculate the wᵢ^{available} as the available bandwidth of the transmission window i according to the formula (4).

The bandwidth of a subcarrier is denoted as Δf, f is the current frequency, h(f) represents the channel impulse response at a frequency f, and |h(f+Δf)−h(f)²≤ε means that the subcarriers are frequency flat.

The above formula (5) is to calculate the total number of subcarriers, N=K+1, where K is the maximum index of the subcarrier, and the subcarrier index is 0, 1, . . . , K.

The opt.1 may make sufficient use of distance-bandwidth mapping information 130, and the opt.2 may effectively use the distance-bandwidth mapping information 130 with low complexity, because the distance-frequency related straight lower and higher frequency decline lines A and B may be transmitted instead of the f_{c}^{up}, f_{c}^{down}, Δf^{up}, Δf^{down} at every granularity of the transmission distance.

In an operation 140, the UE device 110 may identify whether at the bandwidth a subcarrier is an available subcarrier or a virtual subcarrier which fails to support reliable symbol transmission.

In an embodiment, the virtual subcarrier may be the subcarrier in which the instantaneous path loss is greater than a predetermined threshold, denoted as T_{threshold}. The following formula (6) may be used to identify the virtual subcarrier.

$$\{ \begin{matrix}- 20 {log}_{10} ( h ( k ) ) > {T}_{threshold} = \frac{{P}_{t}}{N} + {G}_{t} + {G}_{r} - ( {SNR}_{b}^{average} + {P}_{n} ) \\ {SNR}_{b}^{average} = \frac{{( 1 - 2 {P}_{b}^{BPSK} )}^{2}}{1 - {( 1 - 2 {P}_{b}^{BPSK} )}^{2}}\end{matrix} \qquad ( 6 )$$

Where Pₜ is the fixed total transmission power which can be achieved, Pₙ represents the average noise power at the k-th subcarrier at the UE device 110, Gₜ and Gᵣ represent the transmit and receive antenna gain, respectively, whereas SNR_{b}^{average} stands for the average signal-to-noise ratio (SNR), which is required in order to achieve a bit error rate (BER) denoted as P_{b}^{BPSK}, and h(k) represents the channel impulse response of the k-th subcarrier.

In a case where the h(k) satisfies the formula (6), the k-th subcarrier is identified as the virtual subcarrier, otherwise the k-th subcarrier is identified as the available subcarrier.

In an operation 145, the UE device 110 may estimate channel information at the bandwidth in one or more available subcarriers.

In an embodiment, the UE device 110 may estimate a raw channel H and an effective channel H_{eff} in one or more available subcarriers. In an option, the UE device 110 may estimate the raw channel and the effective channel at the W(d) in all available subcarriers. The raw channel and the effective channel may be described in Matlab link-level simulation (LLS) as below.

Raw channel: tem_chn ∈□^{M×N}, where M is the attenna number (port level) of the UE device 110, and N is the attenna number (port level) of the network apparatus 120.

Effective channel: tem_chn_eff ∈□^{S×N}, where S is the stream number of the UE device 110. The tem_chn_eff and/or the tem_chn may represent the estimated channel information.

Then, the UE device 110 may transmit, to the network apparatus 120, aware information 150 of the UE device 110. The aware information 150 may comprise the channel information, positioning and ephemeris information, and SA index of the UE device 110. The ephemeris information may include a moving direction, a moving velocity, and a planned route of movement of the UE device 110. The SA index may also be array-of-subarrays (AoSA) index, and may be denoted as (mᵣ,nᵣ). The UE device 110 and the network apparatus 120 may include P×P antenna SAs, respectively, and the coordinates of each SA may be the SA index (mᵣ, nᵣ). The UE device 110 feedbacks to the network apparatus 120 the channel information from available subcarriers and its positioning information and its ephemeris as well as the AoSA index, which may help the network apparatus 120 decide an optimal SA spacing, and moreover, the detailed signaling and information exchange between the network apparatus 120 and the UE device 110 may support the implementation of a bandwidth adaptive modulation solution, which will be described later.

Receiving the aware information 150 of the UE device 110, in an operation 155, the network apparatus 120 may calculate a precoder and a norma vector according to the channel information of the UE device 110. In an embodiment, the precoder and the norma vector may be calculated in the Matlab LLS as below.

Temporary Transmit precoding: Tx_prec_tem=pinv(tem_chn_eft) ∈□^{N×N} where N is the attenna number (port level) of the network apparatus 120, and S is the stream number of the UE device 110. B=pinv(A) returns the Moore-Penrose pseudoinverse of A. □ is the complex number domain.

Temporary norma vector: to meet the total transmitted power constraint after pre-equalization norma_vec_tem=abs(diag(Tx_prec_tem′*Tx_prec_tem)) ∈□^{S×1}, where S is the stream number of the UE device 110. Y=abs(X) returns the absolute value of each element in array X, D=diag(v) returns the square diagonal matrix with the elements of vector v on the main diagonal, and □ is the real number domain.

Transmit precoding: Tx Pre(:,:,rb_index)=Tx_prec_tem ∈□^{N×S×RB}^{ₙᵤₘ}, where N is the attenna number (port level) of the network apparatus 120, S is the stream number of the UE device 110, and RBₙᵤₘ is the number of resource blocks (RBs).

Norma vector: norma_vec(:,rb_index)=1./norma_vec_tem.′ ∈□^{S×RB}^{ₙᵤₘ}, where S is the stream number of the UE device 110, and RB is the number of RBs.

The norma vector may be used to meet a total transmitted power constraint after pre-equalization according to the channel information.

In an operation 160, the network apparatus 120 may calculate a distance between a center of transmitting antenna array and a center of receiving antenna array based on the positioning and ephemeris information, and the SA index of the UE device 110, to determine an optimal SA spacing. In an embodiment, the network apparatus 120 may determine the optimal SA spacing Δₒₚᵢₘₐₗ from an original SA spacing through Δₒₚₜᵢₘₐₗ=\sqrt{κ·D·c/P·f}·κis an integer tuning factor. D is communication distance between the center of transmitting antenna array and the center of receiving antenna array, and may be calculated by the network apparatus 120 based on positioning and ephemeris information of the UE device 110. c is the light speed. P is SA dimension, for example, the UE device 110 and the network apparatus 120 may include P×P antenna SAs, respectively. f is the current frequency. Thus, the SA spacing may be adjusted to the Δoptimal for the subsequent transmissions.

The THz channels are orthogonal when the inner product between the corresponding channel columns of two arbitrary transmitting SAs is zero to guarantees above-mentioned optimal AoSA. For uniformly spaced AoSAs, the communication distance D relates to dₘ_{ᵣ}ₙ_{ᵣ}_{,m}_{ₜ}ₙ_{ₜ} in the formula (1). dₘ_{ᵣ}ₙ_{ᵣ}_{,m}_{ₜ}ₙ_{ₜ}={square root over (D²+Δ² ((mᵣ−mₜ)²+(nᵣ−nₜ)²))}, where Δ is the current SA spacing, (mᵣ,nᵣ) may represent the SA index (coordinates) on the UE device 110 side, and (mₜ, nₜ) may represent the SA index (coordinates) on the network apparatus 120 side.

In a case where D>>Δ mₘ_{ᵣ}ₙ_{ᵣ}_{,m}_{ₜ}ₙ_{ₜ}≈D+Δ²(mᵣ−mₜ)²+(nᵣ−nₜ)²)/2D. Hence, the channel gain in the formula (1) can be approximated as the following formula (7).

$${PG}_{{m}_{r} {n}_{r} , {m}_{t} {n}_{t}}^{LoS} = \frac{c}{4 π {f}_{c} D} \times {e}^{- \frac{1}{2} {k}_{abs} ( {f}_{c} ) D} {e}^{- j \frac{2 π {f}_{c}}{c} ( D + \frac{{Δ}^{2} ( {( {m}_{r} - {m}_{t} )}^{2} + {( {n}_{r} - {n}_{t} )}^{2} )}{2 D} )} \qquad ( 7 )$$

In an operation 165, the network apparatus 120 may calculate a SNR at an available subcarrier based on the norma vector and a noise at the available subcarrier at the UE device 110. In an embodiment, the network apparatus 120 may calculate the achieved SNR at the k-th subcarrier SNRₖ^{achieve} as the following formula (8).

$${SNR}_{k}^{achieve} = \frac{{\vert h ( k ) \vert}^{2} P ( k )}{{P}_{n}} \qquad ( 8 )$$

where h(k) is the channel impulse response of the k-th subcarrier, P(k) is the power that allocated to the available subcarriers in the k-th subcarrier, and Pₙ is the average noise power at the k-th subcarrier. The norma vector, norma_vec(:,rb_index)=1./norma_vec_tem.′ ∈□^{S×RB}^{ₙᵤₘ}, may be equivalent to |h(k)²|P(k).

In an operation 170, the network apparatus 120 may select a modulation order based on the SNR at the available subcarrier and a BER requirement. The modulation order per subcarrier may represent a bandwidth adaptive modulation and coding scheme index (IMCS) level per stream, respectively. In an embodiment, the modulation order for the k-th subcarrier, mₖ, is selected in order to ensure a BER requirement, P_{b}. The Mₖ for quadrature amplitude modulation (QAM) may be obtained by the following formula (9).

$$\{ \begin{matrix}{M}_{k} \leq \frac{2 {SNR}_{k}^{achieve}}{3} ( \frac{1}{{( 1 - \frac{2 {P}_{b}}{a} )}^{2}} - 1 ) + 1 \\ a = \{ \begin{matrix}1 , & for {M}_{k} = 4 \\ \frac{4}{{log}_{2} ( {M}_{k} )} , & for {M}_{k} > 4\end{matrix}\end{matrix} \qquad ( 9 )$$

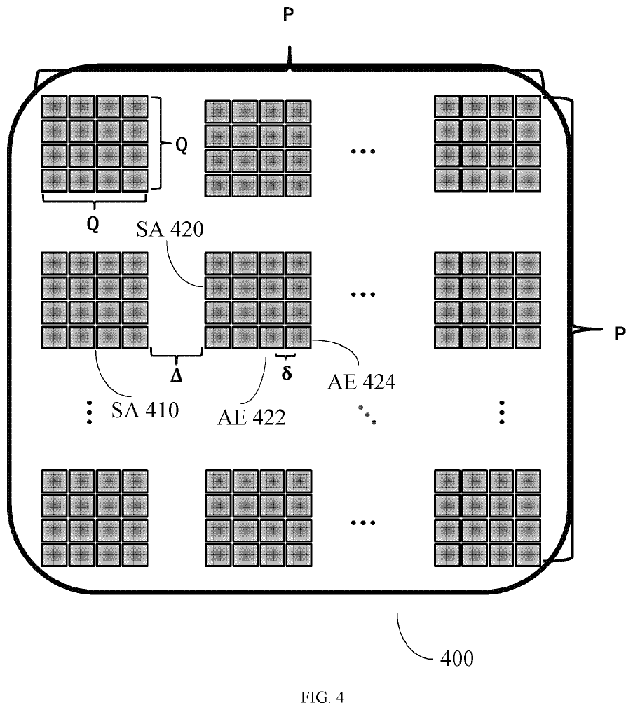

In an operation 175, the network apparatus 120 may extending modulated data to an antenna location at a level of SA or antenna element (AE) according to the modulation order. FIG. 4 shows an example pattern 400 of THz modulation at an array-of-subarrays at antenna level according to an embodiment of the present disclosure. For example, according to the modulation order Mₖ, the modulated data in the network apparatus 120 may be further extended spatially and hierarchically to map information bits to antenna locations at the level of SAs or AEs as shown in the FIG. 4.

As is shown in the FIG. 4, the AoSA at the transmitting and receiving sides includes P×P and P×P SAs, respectively. Furthermore, each SA include a Q×Q set of AEs. A is the SA spacing between two adjacent SAs, e.g., the SA 410 and SA 420, and δ is the distance between two adjacent AEs, e.g. the AE 422 and the AE 424.

Referring back to the FIG. 1, in an operation 180, the network apparatus 120 may calculate a total number of binary bits which are transmitted in downlink over one symbol duration based on the modulation order. In an embodiment, the total number of binary bits that can be transmitted in downlink over one symbol duration, denoted as Data_{stream_bits}, may be calculated by the following formula (10).

$${Data}_{stream\_bits} = {log}_{2} ( {P}^{2} ) + {log}_{2} ( {Q}^{2} ) + {log}_{2} ( \vert {2}^{{M}_{k}} \vert ) \qquad ( 10 )$$

The first item of the right side of the formula (10) is the selected SA, the second item is the selected AE, and the third is that of the proposed supported QAM symbol.

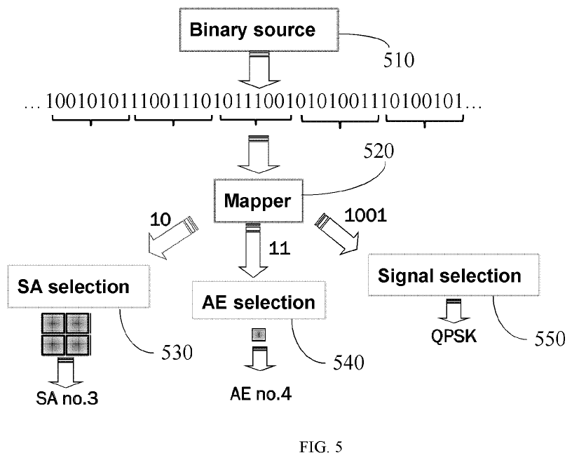

FIG. 5 shows an example THz hierarchically special mapping illustration at subarray and antenna element level according to an embodiment of the present disclosure. In the example shown in the FIG. 5, for example, P²=Q2=Mₖ=4, a mapper 520 maps binary bits “10111001” from a binary source 510 to a SA selection 530, an AE selection 540 and a signal selection 550. The first 2 bits represent the selected SA, and “10” corresponds to the SA no. 3. The middle 2 bits represent the selected AE, and “11” corresponds to the AE no. 4. The last of the binary bits “1001” to the signal selection 550 is that of the QAM symbol for quadrature phase shift keying (QPSK). The total bits is 8.

The modulation mechanism for THz according to the embodiments of the present disclosure may be advantageously suitable for data transmission in downlink and may also be suitable for data transmission in uplink. The hierarchically spatial mapping is to map a piece of information bits into three kinds of information: 1) the signal constellation diagram; 2) the sequence number of the transmitting SA; and 3) the sequence number of the transmitting AE. Radio channels provide different independent modulations to the SA and AE at different locations, the wireless channel is equivalent to a modulation unit. In the receiver, such as the UE device 110, for the first time, the receiver estimates the impulse response of the each channels, and then the receiver computes the Euclidean distance between the received signal and the possible signal modulated through the channel and selects the nearest one so that all the transmitted information can be demodulated.

According to the embodiments of the present disclosure, the distance-bandwidth mapping information 130 may assist hierarchical modulation mechanism to effectively maximize the THz channel utilization. The detailed contents of the MT such as the Table 1 for achieving high accuracy or low complexity respectively may be based on the fact that over shorter distances the available bandwidth is larger, and thus the symbol duration can be made shorter than that for users over longer distances. Furthermore, the spatial modulation may be introduced to embed multiple binary information streams on the same carrier signal at the SA or AE level. By taking into account a predefined reliability and the distance between the UE device 110 and the network apparatus 120, the available bandwidth and the modulation order that maximizes the data rate may be selected.

According to the embodiments of the present disclosure, the distance-bandwidth mapping information 130, e.g., in the MT may be used to effectively decide the related bandwidth W(d) in THz band. Taking into account the SA spacing optimization in THz, the aware information 150 may support the hierarchical modulation.

The embodiments of the present disclosure provide an integrated distance and bandwidth adaptive modulation mechanism for THz, which may map information bits to antenna locations, at the level of SAs or AEs and determine the optimal Δₒₚₜᵢₘₐₗ for the network apparatus based on the feedback positioning information as well as the feedback AoSA index of the UE device.

The embodiments of the present disclosure are suitable for THz channel systems, and combined with the BER requirement, the available bandwidth and the modulation order may maximize achievable data rate in a specific transmission.

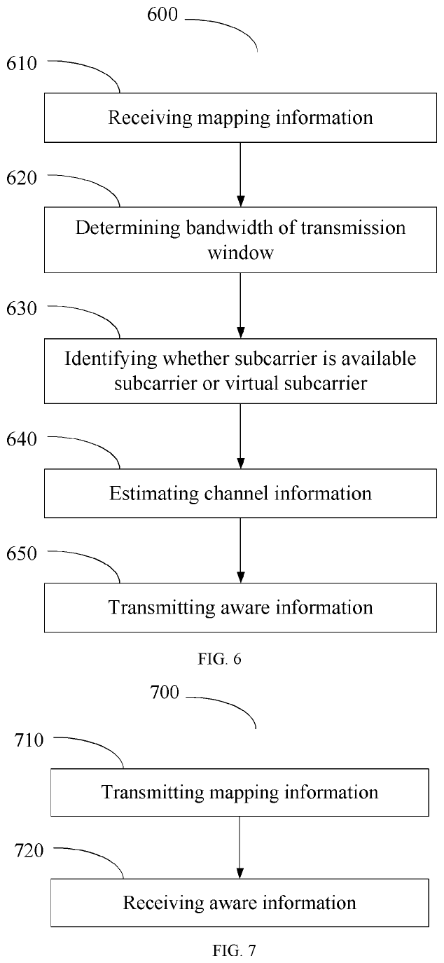

FIG. 6 shows a flow chart illustrating an example method 600 for THz channel communication according to an embodiment of the present disclosure. The example method 600 may be performed for example at a UE device such as the UE device 110.

Referring to the FIG. 6, the example method 600 may include an operation 610 of receiving, from a network apparatus, mapping information on property of distance and bandwidth, an operation 620 of determining a bandwidth of a transmission window based on the mapping information and a distance between the UE device and the network apparatus, an operation 630 of identifying whether at the bandwidth a subcarrier is an available subcarrier or a virtual subcarrier which fails to support reliable symbol transmission, an operation 640 of estimating channel information at the bandwidth in one or more available subcarriers, and an operation 650 of transmitting, to the network apparatus, aware information of the UE device, the aware information comprising the channel information, positioning and ephemeris information, and SA index of the UE device.

Details of the operation 610 have been described in the above descriptions with respect to at least the mapping information 130, and repetitive descriptions thereof are omitted here.

Details of the operation 620 have been described in the above descriptions with respect to at least the operation 135, and repetitive descriptions thereof are omitted here.

Details of the operation 630 have been described in the above descriptions with respect to at least the operation 140, and repetitive descriptions thereof are omitted here.

Details of the operation 640 have been described in the above descriptions with respect to at least the operation 145, and repetitive descriptions thereof are omitted here.

Details of the operation 650 have been described in the above descriptions with respect to at least the aware information 150, and repetitive descriptions thereof are omitted here.

In an embodiment, the mapping information may be in a distance-bandwidth MT. The more details have been described in the above descriptions with respect to at least the Table 1, and repetitive descriptions thereof are omitted here.

In an embodiment, the mapping information may comprise positioning information and/or ephemeris information of the network apparatus. The more details have been described in the above descriptions with respect to at least the mapping information 130, and repetitive descriptions thereof are omitted here.

In an embodiment, the mapping information may comprise a lower absorption line center frequency and a higher absorption line center frequency in the transmission window, and a differential frequency between the lower absorption line center frequency and a falling edge frequency at a lower absorption line and a differential frequency between the higher absorption line center frequency and a falling edge frequency at a higher absorption line of the transmission window. The more details have been described in the above descriptions with respect to at least the mapping information 130 and the FIG. 2, and repetitive descriptions thereof are omitted here.

In an embodiment, the mapping information may comprise parameters of lower and higher frequency decline lines of the transmission window. The more details have been described in the above descriptions with respect to at least the mapping information 130 and the FIG. 3, and repetitive descriptions thereof are omitted here.

In an embodiment, the mapping information may comprise a distance range and/or a granularity of the distance range. The more details have been described in the above descriptions with respect to at least the mapping information 130, and repetitive descriptions thereof are omitted here.

In an embodiment, the mapping information may be transmitted in a SSB. The more details have been described in the above descriptions with respect to at least the mapping information 130, and repetitive descriptions thereof are omitted here.

FIG. 7 shows a flow chart illustrating an example method 700 for THz channel communication according to an embodiment of the present disclosure. The example method 700 may be performed for example at a network apparatus such as the network apparatus 120.

Referring to the FIG. 7, the example method 700 may include an operation 710 of transmitting, to a UE device, mapping information on property of distance and bandwidth, and an operation 720 of receiving, from the UE device, aware information of the user equipment device, the aware information comprising channel information, positioning and ephemeris information, and SA index of the UE device, wherein the channel information may be estimated at a bandwidth of a transmission window in one or more available subcarriers, and the bandwidth may be determined based on the mapping information and a distance between the UE device and the network apparatus.

Details of the operation 710 have been described in the above descriptions with respect to at least the mapping information 130, and repetitive descriptions thereof are omitted here.

Details of the operation 720 have been described in the above descriptions with respect to at least the aware information 150, the mapping information 130, and the operations 135 to 145, and repetitive descriptions thereof are omitted here.

In an embodiment, the example method 700 may further include an operation of calculating a precoder and a norma vector according to the channel information, and an operation of calculating a SNR at an available subcarrier based on the norma vector and a noise at the available subcarrier at the UE device to determine a bandwidth adaptive IMCS level per stream. The more details have been described in the above descriptions with respect to at least the operation 155 and the operation 165, and repetitive descriptions thereof are omitted here.

In an embodiment, the example method 700 may further include an operation of calculating a distance between a center of transmitting antenna array and a center of receiving antenna array based on the positioning and ephemeris information, and the SA index of the UE device, to determine an optimal SA spacing. The more details have been described in the above descriptions with respect to at least the operation 160, and repetitive descriptions thereof are omitted here.

In an embodiment, the example method 700 may further include an operation of selecting a modulation order based on the SNR at the available subcarrier and a BER requirement, an operation of extending modulated data to an antenna location at a level of SA or AE according to the modulation order, and an operation of calculating a total number of binary bits which are transmitted in downlink over one symbol duration based on the modulation order. The more details have been described in the above descriptions with respect to at least the operation 170, the operation 175, and the operation 180, and repetitive descriptions thereof are omitted here.

In an embodiment, the mapping information may be transmitted in a SSB. The more details have been described in the above descriptions with respect to at least the mapping information 130, and repetitive descriptions thereof are omitted here.

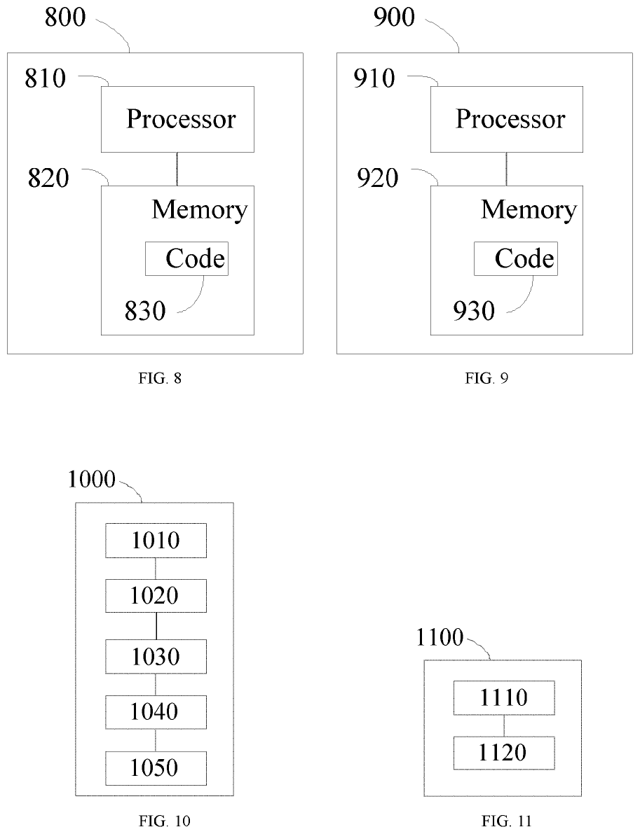

FIG. 8 shows a block diagram illustrating an example apparatus 800 for THz channel communication according to an embodiment of the present disclosure. The apparatus, for example, may be at least part of the UE 110 in the above examples.

As shown in the FIG. 8, the example apparatus 800 may include at least one processor 810 and at least one memory 820 that may include computer program code 830. The at least one memory 820 and the computer program code 830 may be configured to, with the at least one processor 810, cause the apparatus 800 at least to perform the example method 600 described above.

In various example embodiments, the at least one processor 810 in the example apparatus 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 810 may also include at least one other circuitry or element not shown in the FIG. 8.

In various example embodiments, the at least one memory 820 in the example apparatus 800 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 820 may include, but are not limited to, an electric, a magnetic, an optical, an electromagnetic, an infrared, or a semiconductor system, apparatus, or device or any combination of the above.

Further, in various example embodiments, the example apparatus 800 may also include at least one other circuitry, element, and interface, for example at least one I/O interface, at least one antenna element, and the like.

In various example embodiments, the circuitries, parts, elements, and interfaces in the example apparatus 800, including the at least one processor 810 and the at least one memory 820, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the UE 110 is not limited to the above example apparatus 800.

FIG. 9 shows a block diagram illustrating an example apparatus 900 for THz channel communication according to an embodiment of the present disclosure. The apparatus, for example, may be at least part of the network apparatus 120 in the above examples.

As shown in the FIG. 9, the example apparatus 900 may include at least one processor 910 and at least one memory 920 that may include computer program code 930. The at least one memory 920 and the computer program code 930 may be configured to, with the at least one processor 910, cause the apparatus 900 at least to perform at least one of the example method 700 described above.

In various example embodiments, the at least one processor 910 in the example apparatus 900 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 910 may also include at least one other circuitry or element not shown in the FIG. 9.

In various example embodiments, the at least one memory 920 in the example apparatus 900 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 920 may include, but are not limited to, an electric, a magnetic, an optical, an electromagnetic, an infrared, or a semiconductor system, apparatus, or device or any combination of the above.

Further, in various example embodiments, the example apparatus 900 may also include at least one other circuitry, element, and interface, for example at least one I/O interface, at least one antenna element, and the like.

In various example embodiments, the circuitries, parts, elements, and interfaces in the example apparatus 900, including the at least one processor 910 and the at least one memory 920, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the network apparatus 120 is not limited to the above example apparatus 900.

FIG. 10 shows a block diagram illustrating an example apparatus 1000 for THz channel communication according to an embodiment of the present disclosure. The apparatus, for example, may be at least part of the UE 110 in the above examples.

As shown in FIG. 10, the example apparatus 1000 may include means 1010 for performing the operation 610 of the example method 600, means 1020 for performing the operation 620 of the example method 600, means 1030 for performing the operation 630 of the example method 600, means 1040 for performing the operation 640 of the example method 600, and means 1050 for performing the operation 650 of the example method 600. In one or more another example embodiments, at least one I/O interface, at least one antenna element, and the like may also be included in the example apparatus 1000.

In some example embodiments, examples of means in the example apparatus 1000 may include circuitries. For example, an example of means 1010 may include a circuitry configured to perform the operation 610 of the example method 600, an example of means 1020 may include a circuitry configured to perform the operation 620 of the example method 600, an example of means 1030 may include a circuitry configured to perform the operation 630 of the example method 600, an example of means 1040 may include a circuitry configured to perform the operation 640 of the example method 600, and an example of means 1050 may include a circuitry configured to perform the operation 650 of the example method 600. In some example embodiments, examples of means may also include software modules and any other suitable function entities.

FIG. 11 shows a block diagram illustrating an example apparatus 1100 for THz channel communication according to an embodiment of the present disclosure. The apparatus, for example, may be at least part of the network apparatus 120 in the above examples.

As shown in the FIG. 11, the example apparatus 1100 may include means 1110 for performing the operation 710 of the example method 700, and means 1120 for performing the operation 720 of the example method 700. In one or more another example embodiments, at least one I/O interface, at least one antenna element, and the like may also be included in the example apparatus 1100.

In some example embodiments, examples of means in the example apparatus 1100 may include circuitries. For example, an example of means 1110 may include a circuitry configured to perform the operation 710 of the example method 700, and an example of means 1120 may include a circuitry configured to perform the operation 720 of the example method 700. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and acts of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
AE antenna element
AoSA array-of-subarrays
BER bit error rate
BS base station
CN core network
GNSS global navigation satellite system
IMCS modulation and coding scheme index
LLS link-level simulation
LoS line of sight
MT mapping table
NLoS non-LoS
PBCH physical broadcast channel
RB resource block
QAM quadrature amplitude modulation
QPSK quadrature phase shift keying
SA subarray
SNR signal-to-noise ratio
SSB synchronization signal block
THz terahertz
UAV unmanned aerial vehicle
UE user equipment

1. A communication method performed by a user equipment device, said method comprising:
receiving, from a network apparatus, mapping information on property of distance and bandwidth;
determining a bandwidth of a transmission window based on the mapping information and a distance between the user equipment device and the network apparatus;
identifying whether at the bandwidth a subcarrier is an available subcarrier or a virtual subcarrier which fails to support reliable symbol transmission;
estimating channel information at the bandwidth in one or more available subcarriers; and
transmitting, to the network apparatus, aware information of the user equipment device, the aware information comprising the channel information, positioning and ephemeris information, and subarray index of the user equipment device.

2. The communication method of claim 1, wherein the mapping information is in a distance-bandwidth mapping table.

3. The communication method of claim 1, wherein the mapping information comprises positioning information and/or ephemeris information of the network apparatus.

4. The communication method of claim 1, wherein the mapping information comprises a lower absorption line center frequency and a higher absorption line center frequency in the transmission window, and a differential frequency between the lower absorption line center frequency and a falling edge frequency at a lower absorption line and a differential frequency between the higher absorption line center frequency and a falling edge frequency at a higher absorption line of the transmission window.

5. The communication method of claim 1, wherein the mapping information comprises parameters of lower and higher frequency decline lines of the transmission window.

6. The communication method of claim 1, wherein the mapping information comprises a distance range and/or a granularity of the distance range.

7. The communication method of claim 1, wherein the mapping information is transmitted in a synchronization signal block.

8. A communication method performed by a network apparatus, said method comprising:
transmitting, to a user equipment device, mapping information on property of distance and bandwidth; and
receiving, from the user equipment device, aware information of the user equipment device, the aware information comprising channel information, positioning and ephemeris information, and subarray index of the user equipment device, wherein
the channel information is estimated at a bandwidth of a transmission window in one or more available subcarriers, and the bandwidth is determined based on the mapping information and a distance between the user equipment device and the network apparatus.

9. The communication method of claim 8, further comprising:
calculating a precoder and a norma vector according to the channel information; and
calculating a signal-to-noise ratio at an available subcarrier based on the norma vector and a noise at the available subcarrier at the user equipment device to determine a bandwidth adaptive modulation and coding scheme index level per stream.

10. The communication method of claim 8, further comprising:
calculating a distance between a center of transmitting antenna array and a center of receiving antenna array based on the positioning and ephemeris information, and the subarray index of the user equipment device, to determine an optimal subarray spacing.

11. The communication method of claim 9, further comprising:
selecting a modulation order based on the signal-to-noise ratio at the available subcarrier and a bit error rate requirement;
extending modulated data to an antenna location at a level of subarray or antenna element according to the modulation order; and
calculating a total number of binary bits which are transmitted in downlink over one symbol duration based on the modulation order.

12. The communication method of claim 8, wherein the mapping information is transmitted in a synchronization signal block.

13. A communication apparatus comprising:
at least one processor; and
at least one memory including computer program code, the at least one memory and the computer program code being configured to, with the at least one processor, cause the communication apparatus as a user equipment device to perform:
receiving, from a network apparatus, mapping information on property of distance and bandwidth;
determining a bandwidth of a transmission window based on the mapping information and a distance between the user equipment device and the network apparatus;
identifying whether at the bandwidth a subcarrier is an available subcarrier or a virtual subcarrier which fails to support reliable symbol transmission;
estimating channel information at the bandwidth in one or more available subcarriers; and
transmitting, to the network apparatus, aware information of the user equipment device, the aware information comprising the channel information, positioning and ephemeris information, and subarray index of the user equipment device.

14. The communication apparatus of claim 13, wherein the mapping information is in a distance-bandwidth mapping table.

15. The communication apparatus of claim 13, wherein the mapping information comprises positioning information and/or ephemeris information of the network apparatus.

16. The communication apparatus of claim 13, wherein the mapping information comprises a lower absorption line center frequency and a higher absorption line center frequency in the transmission window, and a differential frequency between the lower absorption line center frequency and a falling edge frequency at a lower absorption line and a differential frequency between the higher absorption line center frequency and a falling edge frequency at a higher absorption line of the transmission window.

17. The communication apparatus of claim 13, wherein the mapping information comprises parameters of lower and higher frequency decline lines of the transmission window.

18. The communication apparatus of claim 13, wherein the mapping information comprises a distance range and/or a granularity of the distance range.

19. The communication apparatus of claim 13, wherein the mapping information is transmitted in a synchronization signal block.

20. A communication apparatus comprising:
at least one processor; and
at least one memory including computer program code, the at least one memory and the computer program code being configured to, with the at least one processor, cause the communication apparatus as a network apparatus to perform:
transmitting, to a user equipment device, mapping information on property of distance and bandwidth; and
receiving, from the user equipment device, aware information of the user equipment device, the aware information comprising channel information, positioning and ephemeris information, and subarray index of the user equipment device, wherein
the channel information is estimated at a bandwidth of a transmission window in one or more available subcarriers, and the bandwidth is determined based on the mapping information and a distance between the user equipment device and the network apparatus.

21. The communication apparatus of claim 20, wherein the at least one memory and the computer program code are further configured to, with the at least one processor, cause the communication apparatus to further perform:
calculating a precoder and a norma vector according to the channel information; and,
calculating a signal-to-noise ratio at an available subcarrier based on the norma vector and a noise at the available subcarrier at the user equipment device to determine a bandwidth adaptive modulation and coding scheme index level per stream.

22. The communication apparatus of claim 20, wherein the at least one memory and the computer program code are further configured to, with the at least one processor, cause the communication apparatus to further perform:
calculating a distance between a center of transmitting antenna array and a center of receiving antenna array based on the positioning and ephemeris information, and the subarray index of the user equipment device, to determine an optimal subarray spacing.

23. The communication apparatus of claim 21, wherein the at least one memory and the computer program code are further configured to, with the at least one processor, cause the communication apparatus to further perform:
selecting a modulation order based on the signal-to-noise ratio at the available subcarrier and a bit error rate requirement;
extending modulated data to an antenna location at a level of subarray or antenna element according to the modulation order; and
calculating a total number of binary bits which are transmitted in downlink over one symbol duration based on the modulation order.

24. The communication apparatus of claim 20, wherein the mapping information is transmitted in a synchronization signal block.

25. (canceled)

26. (canceled)

27. A computer readable medium comprising program instructions for causing a communication apparatus as a user equipment device to perform:
receiving, from a network apparatus, mapping information on property of distance and bandwidth;
determining a bandwidth of a transmission window based on the mapping information and a distance between the user equipment device and the network apparatus;
identifying whether at the bandwidth a subcarrier is an available subcarrier or a virtual subcarrier which fails to support reliable symbol transmission;
estimating channel information at the bandwidth in one or more available subcarriers; and
transmitting, to the network apparatus, aware information of the user equipment device, the aware information comprising the channel information, positioning and ephemeris information, and subarray index of the user equipment device.

28. A computer readable medium comprising program instructions for causing a communication apparatus as a network apparatus to perform:
transmitting, to a user equipment device, mapping information on property of distance and bandwidth; and
receiving, from the user equipment device, aware information of the user equipment device, the aware information comprising channel information, positioning and ephemeris information, and subarray index of the user equipment device, wherein
the channel information is estimated at a bandwidth of a transmission window in one or more available subcarriers, and the bandwidth is determined based on the mapping information and a distance between the user equipment device and the network apparatus.
